(19) United States
(12) Patent Application Publication
(10) Pub. No.: US 2010/0000760 A1
(43) Pub. Date: Jan. 7, 2010

(54) BALANCED DATA CABLE FOR COMMUNICATIONS AND DATA TECHNOLOGY

(75) Inventor: Ulrich Hetzer, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/375,647

(22) PCT Filed: Jul. 18, 2007
(86) PCT No.: PCT/EP2007/006364

§ 371 Date: Jan. 29, 2009

(30) Foreign Application Priority Data
Aug. 2, 2006 (DE) 10 2006 036 065.6

(51) Int. Cl. H01B 11/04

(52) U.S. Cl. 174/113 R

(57) ABSTRACT

The invention relates to a balanced data cable (1) for communications and data technology, having at least one guide element (3), a cable sheath (2) and at least two balanced line pairs (4), which are guided, twisted in pairs, in channels in the guide element (3) with the guide element (3) and/or the cable sheath (2) being composed at least partially of ferrite material.

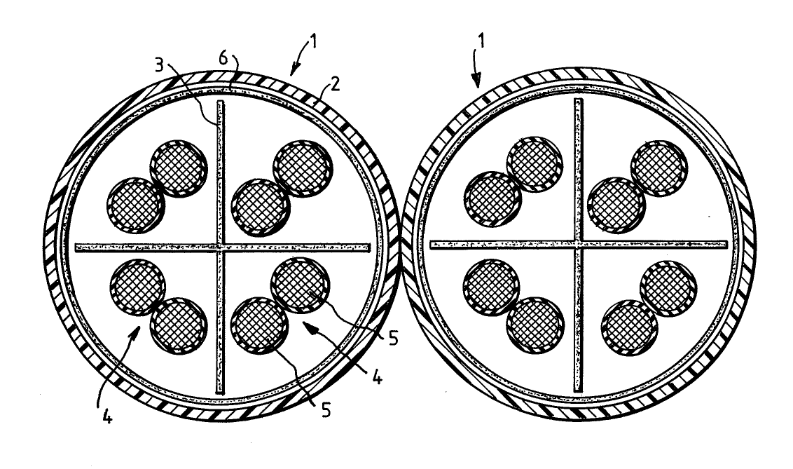

The invention relates to a symmetrical data cable for communications and data engineering.

Symmetrical data cables have at least one symmetrical line pair, which is generally twisted. The data cables also have a cable sheath, which surrounds the line pairs. In addition, it is known to provide electrical shielding between the cable sheath and the line pairs in order to shield electrical faults. For a defined position of the line pairs, the use of guide elements is known in whose channels the line pairs are guided in pairs. Owing to the transmission frequencies which are becoming ever higher in the case of CAT 6 or 10 Gbit/s Ethernet, the requirements placed on the data cables specifically for crosstalk between the cables are correspondingly higher.

The invention is therefore based on the technical problem of providing a symmetrical data cable which has improved transmission properties.

The solution to the technical problem is given by the subject matters having the features of claims 1 and 5. Further advantageous refinements are given in the dependent claims.

In this regard, the symmetrical data cable for telecommunications and data engineering comprises at least one guide element, a cable sheath and at least two symmetrical line pairs, which are guided, twisted in pairs, in channels in the guide element, the guide element and/or the cable sheath at least partially consisting of a ferrite material. As a result, in each case advantageous properties are achieved which also supplement one another synergistically. Owing to the fact that the cable sheath is formed from a ferrite material, the crosstalk between adjacent data cables is reduced, since, on the one hand, the input of interference radiation and, on the other hand, the output of interference radiation are suppressed. On the other hand, also in contrast to a shielding, no inductance is produced which in turn could be disruptive. The fact that the guide element is formed at least partially from a ferrite material in turn reduces the crosstalk between one line pair and other line pairs in the same data cable. The invention is preferably used for unshielded data cables (UTPs).

In one preferred embodiment, the guide element and/or the cable sheath are formed from a ferrite-coated plastic.

In addition or as an alternative, the guide element and/or the cable sheath may be formed from a ferrite-filled plastic. This has certain advantages since, as a result, the elasticity of the cable sheath and of the guide element is maintained more effectively. Furthermore, embedding in the plastic of the cable or the guide element also represents effective protection against undesirable magnetic short circuits. In this case mention will be made of the fact that it is quite sufficient if the cable sheath or the guide element are formed only in sections from the ferrite material in the longitudinal direction.

In one further preferred embodiment, the guide element is in the form of a cross in cross section, further preferably the guide element being turned in the longitudinal direction such that the line pairs are also twisted with respect to one another in the longitudinal direction. In principle, however, other profiles for the guide element are also conceivable, for example a plate-shaped design, which is then preferably turned in the longitudinal direction. Further preferably the data cable comprises four line pairs.

In embodiments without a guide element (for example in the case of only one line pair), correspondingly only the cable sheath is formed from a ferrite material.

The invention will be explained in more detail below with reference to a preferred exemplary embodiment. The single figure shows a schematic cross section through two data cables according to the invention.

The two symmetrical data cables 1 each have a cable sheath 2 and a guide element 3, which has a cross section in the form of a cross. The four sectors formed by the guide element 3 form channels, in which in each case line pairs 4 are guided. In this case, the two lines 5 of a line pair 4 are twisted. The guide element 3 consists of a ferrite-filled plastic, whereas the cable sheath 2 has a ferrite coating 6, which extends over the entire circumference of the cable sheath 2. Owing to the ferrite coating 6, in this case crosstalk between a data cable 1 and the adjacent data cable 1 is prevented, whereas crosstalk between a line pair 4 and an adjacent line pair 4 is reduced within a data cable 1 by the guide element 3 consisting of a ferrite-filled plastic since the magnetic lines of force can only propagate at the narrow passage between the guide element 3 and the ferrite coating from one channel into the other channel of the guide element.

### LIST OF REFERENCE SYMBOLS

1 Data cable
2 Cable sheath
3 Guide element
4 Line pairs
5 Lines
6 Ferrite coating

1. A symmetrical data cable for communications and data engineering, comprising at least one guide element, a cable sheath and at least two symmetrical line pairs, which are guided, twisted in pairs, in channels in the guide element, wherein the guide element or the cable sheath at least partially consist of a ferrite material.

2. The symmetrical data cable as claimed in claim 1, wherein the guide element or the cable sheath consist of a ferrite-coated plastic.

3. The symmetrical data cable as claimed in claim 1, wherein the guide element or the cable sheath consist of ferrite-filled plastic.

4. The symmetrical data cable as claimed in claim 1, wherein the guide element is in the form of a cross in cross section.

5. A symmetrical data cable for communications and data engineering, comprising at least one symmetrical line pair and a cable sheath, wherein the cable sheath at least partially consists of a ferrite material.

6. The symmetrical data cable as claimed in claim 5, wherein the cable sheath consists of a ferrite-coated plastic or a ferrite-filled plastic
